(19) United States
(12) Patent Application Publication
(10) Pub. No.: US 2026/0099116 A1
(43) Pub. Date: Apr. 9, 2026

(54) COOLING OF FUSER BASED ON TEMPERATURE OF PRESSURE MEMBER

(71) Applicant: Hewlett-Packard Development Company, L.P., Spring, TX (US)

(72) Inventors: Sunhyung Lee, Seongnam-si, Gyeonggi-do (KR); Sungwoo Kang, Seongnam-si, Gyeonggi-do (KR); Seungjun Lee, Seongnam-si, Gyeonggi-do (KR)

(73) Assignee: Hewlett-Packard Development Company, L.P., Spring, TX (US)

(21) Appl. No.: 19/112,936

(22) PCT Filed: Mar. 25, 2023
(86) PCT No.: PCT/US2023/016346

§ 371 Date: Mar. 18, 2025

(30) Foreign Application Priority Data
Oct. 12, 2022 (KR) 10-2022-0130816

(51) Int. Cl. G03G 15/20; G03G 21/20

(52) U.S. Cl. CPC G03G 15/2039; G03G 15/2017; G03G 15/2064; G03G 21/206; G03G 2221/1645

(57) ABSTRACT

A printing apparatus can include a fuser including a fusing member, a heater configured to heat the fusing member, and a pressure member configured to form, together with the fusing member, a fusing nip through which the print medium passes, a ventilation device to supply air to the fusing member in a width direction, a first temperature sensor configured to detect a temperature of a non-paper passing area of the pressure member, a controller configured to control the ventilation device based on the temperature detected by the first temperature sensor.

### CROSS-REFERENCE TO RELATED APPLICATIONS

This application claims priority to Korean Patent Application No. 10-2022-0130816, filed Oct. 12, 2022, which is incorporated by reference herein in its entireties.

### BACKGROUND

A printing apparatus using an electrophotographic method can supply toner to an electrostatic latent image formed on a photoconductor to form a visible toner image on the photoconductor, transfers the toner image directly or through an intermediate transfer medium to a print medium, and then fixes the transferred toner image to the print medium. A fuser is used to fix the toner image transferred to the print medium to the print medium by applying heat and pressure to the toner image. The fuser has a fusing area larger than a width of the print medium. A temperature of the fusing area is controlled to be maintained at a certain fusing temperature. A portion of the fusing area through which the print medium does not pass may have a higher temperature than that of a portion through which the print medium passes.

### BRIEF DESCRIPTION OF THE DRAWINGS

FIG. 1 is a schematic configuration view illustrating a printing apparatus, according to an example.

FIG. 2 is a schematic plan view illustrating a cooling structure of a fuser, according to an example.

FIG. 3 is a schematic plan view illustrating a cooling structure of a fuser, according to an example.

FIG. 4 is a schematic plan view illustrating a cooling structure of a fuser, according to an example.

FIG. 5 is a schematic plan view illustrating a cooling structure of a fuser, according to an example.

FIG. 6 is a schematic plan view illustrating a cooling structure of a fuser, according to an example.

FIG. 7 is a schematic plan view illustrating a case where a print medium with an intermediate width for printing in the cooling structure of the fuser of FIG. 6, according to an example.

FIG. 8 is a schematic plan view illustrating a case where a print medium with a maximum width for printing in the cooling structure of the fuser of FIG. 6, according to an example.

### DETAILED DESCRIPTION

At least one aspect is directed to a printing apparatus that can include a toner image forming unit configured to form a toner image on a print medium. The apparatus can include a fuser configured to fix the toner image to the print medium, the fuser can include a fusing member, a heater configured to heat the fusing member, and a pressure member configured to form, together with the fusing member, a fusing nip through which the print medium passes. The apparatus can include a ventilation device configured to supply air to the fusing member in a width direction. The apparatus can include a first temperature sensor configured to detect a temperature of a non-paper passing area of the pressure member. The apparatus can include a controller configured to control the ventilation device based on the temperature detected by the first temperature sensor.

At least one aspect is directed to a printing apparatus that can include a toner image forming unit configured to form a toner image on a print medium. The apparatus can include a fuser configured to fix the toner image to the print medium, the fuser can include a fusing belt, a heater configured to heat the fusing belt, and a pressure roller configured to form, together with the fusing belt, a fusing nip through which the print medium passes. The apparatus can include first and second ventilation devices configured to supply air to the fusing belt in a width direction. The ventilation device can be configured to supply air to both ends of the fusing member in the width direction. The apparatus can include a plurality of first temperature sensors arranged in the width direction and configured to detect a temperature of a non-paper passing area on a side of the pressure roller. The apparatus can include a controller configured to control the first and second ventilation devices based on the temperature of the non-paper passing area of the pressure roller detected by the first temperature sensor located outside a width of the print medium from among the plurality of first temperature sensors.

At least one aspect is directed to a fuser that can include a fusing belt. The fuser can include a heater configured to heat the fusing belt. The fuser can include a pressure member configured to form, together with the fusing belt, a fusing nip through which the print medium passes. The fuser can include at least one first temperature sensor configured to detect a temperature of a non-paper passing area of the pressure member.

A printing apparatus for printing an image on a print medium by using an electrophotographic method can include a toner image forming unit configured to form a toner image on the print medium by using an electrophotographic method and a fuser configured to fix the toner image to the print medium by applying heat and pressure to the toner image. The fuser can include a fusing nip with a width greater than a width of a largest print medium that may be used in the printing apparatus. The fusing nip may be divided into a paper passing area and a non-paper passing area according to a size of the print medium. The paper passing area can include an area through which the print medium passes, and the non-paper passing area can include an area through which the print medium does not pass. A temperature of the fusing nip can be controlled to be maintained at a certain fusing temperature. Because the non-paper passing area can be prevented from losing heat to the print medium, the non-paper passing area is more likely to be overheated than the paper passing area. Overheating may negatively affect the lifetime of the fuser. For example, when the fuser is overheated, it may have a negative thermal effect on other elements of the printing apparatus around the fuser. In order not to overheat the non-paper passing area, cooling air may be supplied to a portion of the fuser corresponding to the non-paper passing area.

A printing apparatus according to an example of the disclosure can include a toner image forming unit configured to form a toner image on a print medium, a fuser configured to fix the toner image to the print medium, a ventilation device, and a controller configured to control the ventilation device. The fuser can include a fusing member (e.g., a fusing roller or a fusing belt) heated by a heater (e.g., a halogen lamp or a planar heater), and a pressure member (e.g., a pressure roller) configured to form, together with the fusing member, a fusing nip through which the print medium passes.

The ventilation member can supply air to both ends of the fusing member. The controller may control the ventilation device based on a temperature of a non-paper passing area. A printing apparatus according to an example of the disclosure can include a first temperature sensor configured to detect a temperature of the non-paper passing area of the pressure member. The controller can control the ventilation device based on the temperature of the non-paper passing area of the pressure member detected by the first temperature sensor. For example, the first temperature sensor may be located outside a print medium with a maximum width in a width direction from among print media usable in the printing apparatus with respect to the pressure member. For example, the controller may operate the ventilation device when the detected temperature is equal to or higher than a reference temperature, and may stop the ventilation device when the detected temperature is lower than the reference temperature. Because the first temperature sensor is less affected by cooling air from the ventilation device, the first temperature sensor may reliably detect a temperature of the non-paper passing area of the pressure member. For example, because the first temperature sensor does not interfere with supply of cooling air to the fusing member, overheating of the non-paper passing area of the fusing member may be effectively prevented.

A central portion of the pressure member can include a paper passing area regardless of a width of the print medium. For example, the controller may control the ventilation device based on a difference between a temperature of the paper passing area of the pressure member and a temperature of the non-paper passing area of the pressure member. A temperature around the central portion of the pressure member may be detected by using a second temperature sensor. The controller may operate the ventilation device when a temperature detected by the first temperature sensor is higher than a temperature detected by the second temperature sensor, by a certain reference difference or more.

A plurality of print media with various widths may be used in the printing apparatus. The first temperature sensor may include a plurality of first temperature sensors located outside the plurality of print media in the width direction and configured to detect a temperature of the pressure member. The controller may control the ventilation device based on a detection result of a first temperature sensor. The first temperature sensor can be located outside a print medium used for printing in the width direction from among the plurality of first temperature sensors.

The first temperature sensor may be located on a side of the print medium in the width direction. The ventilation device may include first and second ventilation devices that supply air to both ends of the fusing member. For example, a third temperature sensor may be located outside a print medium with a maximum width on the opposite side to the first temperature sensor to detect a temperature of the pressure member. The controller may determine whether the ventilation device malfunctions according to temperature detection results of the third temperature sensor and the first temperature sensor located outside the print medium. For example, the controller may determine whether the first ventilation device and/or the second ventilation device malfunctions, by comparing a temperature detected by the temperature sensor for detecting a temperature of the non-paper passing area of the pressure member with a temperature detected by the third temperature sensor.

For example, the ventilation device may include a ventilation hole facing the fusing member, a ventilator for supplying cooling air, a shutter for adjusting an opening amount of the ventilation hole, and an actuator for driving the shutter. The controller may control the actuator to adjust an opening amount of the ventilation hole based on information about a width of the print medium. A width of the non-paper passing area varies according to a width of the print medium used for printing. Cooling air may be supplied to the non-paper passing area of the fusing member to be cooled, by adjusting an opening amount of the ventilation hole according to a width of the print medium. The information about the width of the print medium may be obtained from one or more of user setting information, detection information of a width detection sensor for detecting a width of the print medium, and detection temperature information of the plurality of first temperature sensors.

The first temperature sensors may be located to be less affected by cooling air. The ventilation device can supply air to the non-paper passing area of the fusing member. Considering this point, the first temperature sensors may be located opposite to the ventilation device with respect to the fusing nip. The second temperature sensor and the third temperature sensor may also be located opposite to the ventilation device with respect to the fusing nip. At least one of the first temperature sensor, the second temperature sensor, and the third temperature sensor may be a non-contact temperature sensor.

A fuser according to an example of the disclosure may include a fusing belt, a heater configured to heat the fusing belt, a pressure member configured to form, together with the fusing belt, a fusing nip through which a print medium passes, and at least one first temperature sensor configured to detect a temperature of a non-paper passing area of the pressure member. The above description of the first temperature sensor, the second temperature sensor, the third temperature sensor, and the fourth temperature sensor and the arrangement thereof may be applied to the fuser, for example.

Examples of a fuser and a printing apparatus will be described with reference to the attached drawings. The same reference numerals in the drawings denote elements having the same functions, and the size of each element may be exaggerated for clarity and convenience of explanation. In the drawings, X, Y, and Z represent three directions perpendicular to one another. For example, a Y direction is a width direction of a print medium P, a Z direction is a direction in which the print medium P passes through a fusing nip N described below, and an X direction is a direction perpendicular to the Y direction and the Z direction.

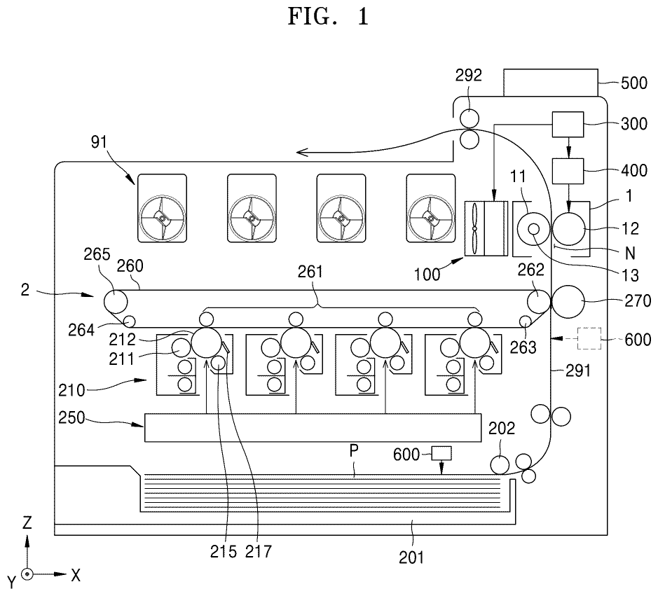

FIG. 1 is a schematic configuration view illustrating a printing apparatus, according to an example. Referring to FIG. 1, a printing apparatus according to an example can include a toner image forming unit 2, a fuser 1, a ventilation device 100, a first temperature sensor 400, and a controller 300. The toner image forming unit 2 forms a toner image on the print medium P. The fuser 1 fixes the toner image to the print medium P by applying heat and pressure to the toner image. The fuser 1 may include a fusing member 11, a heater 13 for heating the fusing member 11, and a pressure member 12 for forming, together with the fusing member 11, the fusing nip N through which the print medium P passes. The ventilation device 100 can supply air to both ends of the fusing member 11 in a width direction Y. For example, the supplied air can correspond to cooling air, but is not limited thereto. The width direction Y can correspond to a longitudinal direction of the fusing member 11, and can correspond to a direction perpendicular to a transport direction in which the print medium P is transported. The first temperature sensor 400 can detect overheating of the fusing member 11. The first temperature sensor 400 can detect overheating of the fusing member 11, by detecting a temperature of a non-paper passing area of the pressure member 12. The non-paper passing area can include an area through which the print medium P does not pass in an entire length of the pressure member 12 in the width direction Y. In the non-paper passing area, the pressure member 12 does not contact the print medium P. The controller 300 can control the ventilation device 100 based on a temperature of the non-paper passing area of the pressure member 12 detected by the first temperature sensor 400. The fuser 1 can include the fusing member 11 and the pressure member 12. The heater 13 heats the fusing member 11. The fusing member 11 and the pressure member 12 may be engaged with each other to form the fusing nip N. The print medium P having one surface (e.g., an image surface) on which a toner image is formed passes through the fusing nip N. Heat transfer can occur from the fusing member 11 to the print medium P at the fusing nip N.

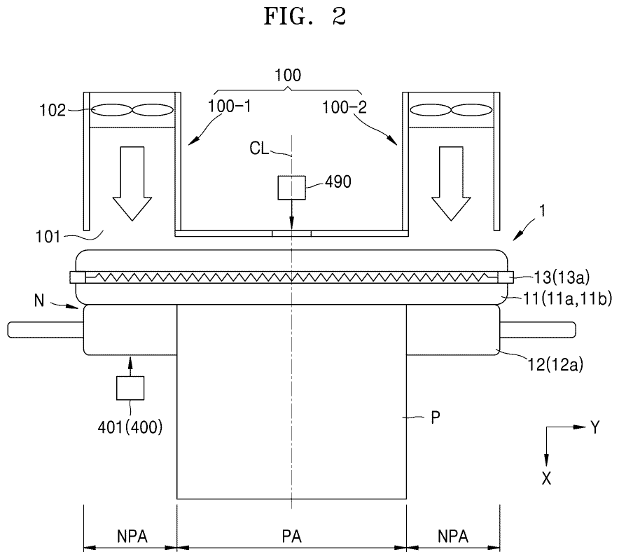

Examples of a cooling structure of the fuser 1 will be described with reference to FIGS. 2 to 8. The print medium P can move in the X direction in FIGS. 2 to 8 for convenience of illustration, and the print medium P can further be transported in the Z direction when passing through the fuser 1.

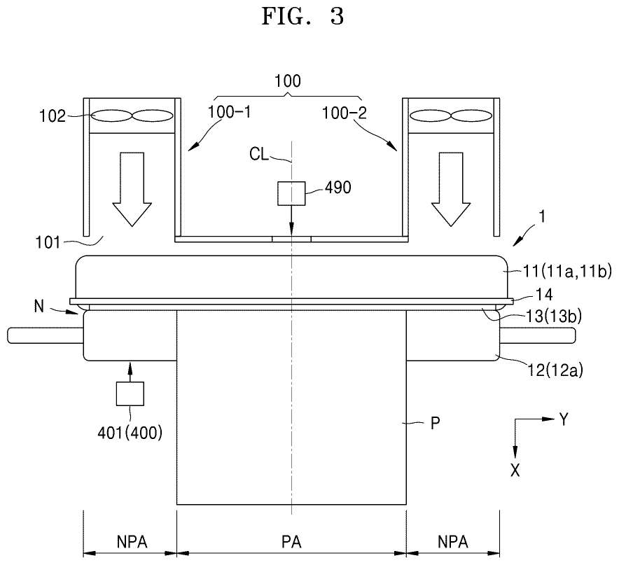

FIG. 2 is a schematic plan view illustrating a cooling structure of the fuser 1, according to an example. FIG. 3 is a schematic plan view illustrating a cooling structure of the fuser 1, according to an example. Referring to FIGS. 2 and 3, the fusing member 11 may be, for example, a fusing roller 11a. The fusing roller 11a may include a hollow metal core. The hollow metal core may be formed of, for example, aluminum. A release layer for improving separability may be provided on an outer circumference of the hollow metal core. The release layer may include at least one of perfluoroalkoxy (PFA), polytetrafluoroethylene (PTFE), and fluorinated ethylene propylene (FEP). The heater 13 may be located inside the hollow metal core to heat the fusing roller 11a. A halogen lamp 13a may be used as the heater 13. The pressure member 12 may be a pressure roller 12a facing the fusing roller 11a. The pressure roller 12a may include a heat-resistant elastic layer. The fusing roller 11a and the pressure roller 12a can be pressed against each other by an elastic member (not shown) to form the fusing nip N. The print medium P may enter the fusing nip N so that an image surface on which a toner image is formed faces the fusing roller 11a, and when the fusing roller 11a and the pressure roller 12a rotate, the print medium P inside the fusing nip N may be transported.

Referring to FIGS. 2 and 3, the fusing member 11 may be, for example, a fusing belt 11b. The fusing belt 11b may include a flexible base layer (not shown). The base layer may be formed of a metal thin film such as stainless steel, nickel, or nickel-copper. The base layer may be formed of a polymer film having heat resistance and abrasion resistance which may withstand a fusing temperature such as a polyimide film, a polyamide film, or a polyimideamide film. A thickness of the base layer may range from 30 μm to 200 μm, for example, 50 μm to 100 μm. A release layer (not shown) may be provided on a surface of the base layer close to the pressure member 12 or both surfaces of the base layer. The release layer may be a resin layer having excellent separability. The release layer may include at least one of PFA, PTFE, and FEP. A thickness of the release layer may range from, for example, 10 μm to 50 μm. In order to form a relatively wide and flat fusing nip, an elastic layer (not shown) may be located between the base layer and the release layer. The elastic layer may be formed of a material having heat resistance and electrical insulation which may withstand a fusing temperature. For example, the elastic layer may include at least one of a rubber material such as fluoro-rubber, silicone rubber, natural rubber, isoprene rubber, butadiene rubber, nitrile rubber, chloroprene rubber, butyl rubber, acrylic rubber, hydrin rubber, or urethane rubber, and various thermoplastic elastomers such as styrene-based, polyolefin-based, polyvinyl chloride-based, polyurethane-based, polyester-based, polyamide-based, polybutadiene-based, trans-polyisoprene-based, and chlorinated polyethylene-based elastomers.

The pressure member 12 may be the pressure roller 12a facing the fusing belt 11b. The pressure roller 12a may include a heat-resistant elastic layer. The heater 13 may be located inside the fusing belt 11b to heat the fusing belt 11b. The heater 13, a halogen lamp 13a (see FIG. 2) located inside the fusing belt 11b, or a planar heater 13b (see FIG. 3) contacting an inner circumference of the fusing belt 11b can directly heat the fusing belt 11b. The planar heater 13b may include a ceramic substrate and a metal heating element formed on the ceramic member. The ceramic substrate may be formed of, for example, alumina or aluminum oxide (Al₂O₃) or aluminum nitride (AlN), and the metal heating element may be formed of an Ag—Pd alloy. Ag—Pt or Ag is mainly used as an electrode layer for supplying current to the metal heating element. An insulating layer covers the metal heating element. A glass insulating layer may be used as the insulating layer contacting the fusing belt 11b. When a surface opposite to a heating surface is a surface contacting the fusing belt 11b, a glass layer or a polyimide layer may be formed as a sliding contact layer on the surface. Because the fuser 1 using the fusing belt 11b and the planar heater 13b can directly heat the fusing belt 11b at the fusing nip N, heat loss can be small and thermal efficiency can be high. Accordingly, a time from an input of a print command to an output of an image of a first page may be reduced. The time can correspond to a first print out time (FPOT). For example, power consumption in a standby state waiting for a print command and power consumption required for printing may be reduced.

A support member 14 may be located inside the fusing belt 11b. The support member 14 and the planar heater 13b and the pressure roller 12a can be pressed against each other with the fusing belt 11b therebetween to form the fusing nip N. The print medium P may enter the fusing nip N so that an image surface on which a toner image is formed faces the fusing belt 11b, and when the pressure roller 12a rotates, the fusing belt 11b may circulate and the print medium P inside the fusing nip N may be transported.

The controller 300 can control a printing process. The controller 300 may be a collection of electronic elements for controlling a printing process. The controller 300 may include at least one processor corresponding, for example, to a central processing unit (CPU). The controller 300 may include a memory. An application program including various instructions for controlling a printing process and various control factors for control may be stored in the memory. A processor may control a printing process by executing the application program. The controller 300 may include a communication unit for communication with a host. The controller 300 may include various control elements, for example, a driving circuit for driving a ventilator 102 and an actuator 104 described below.

The controller 300 can control the heater 13 to maintain the fusing member at a certain fusing temperature at the fusing nip N. For example, the controller 300 may detect a temperature of the fusing member 11 by using a fusing temperature sensor 490, and may control the heater 13 based on the detected temperature. The fusing temperature sensor 490 may be, for example, a thermistor. The fusing temperature sensor 490 may be located, for example, outside the fusing member 11 to detect a surface temperature of the fusing member 11. The fusing temperature sensor 490 may be located, for example, inside the fusing belt 11b to detect a temperature of an inner surface of the fusing belt 11b at the fusing nip N. In order for the fusing temperature sensor 490 to be less or not affected by cooling air supplied to the fusing member 11 by the ventilation device 100, the fusing temperature sensor 490 may be located to detect a surface temperature of a paper passing area PA of the fusing member 11. For example, the fusing temperature sensor 490 may detect a temperature of a portion between first and second ventilation devices 100-1 and 100-2 described below, on a surface of the fusing member 11.

For example, the print medium P may be transported by using a center feeding method to pass through the fuser 1. The term “center feeding method” can refer to a method by which the print media P with various widths are transported so that center lines of the print media P in the width direction Y are matched. When the print media P are transported by using a center feeding method, the print media P may be transported so that the center of the print medium P in the width direction Y coincides with the center of the fuser 1 in the width direction Y, for example, a center line CL of the fusing nip N in the width direction Y. However, the disclosure is not limited thereto, and the center of the print medium P transported by using a center feeding method in the width direction Y may not coincide with the center line CL of the fusing nip N in the width direction Y.

A width of the fusing nip N can be greater than a width of the print medium P having a maximum size that may be used in the printing apparatus. That is, lengths of the fusing member 11 and the pressure member 12 in the width direction Y can be greater than a width of the print medium P having the maximum size. Even when the print medium P having the maximum size passes through the fusing nip N, both ends of the fusing nip N in the width direction Y can be non-paper passing areas NPA through which the print medium P does not pass. In the non-paper passing areas NPA, the print medium P does not contact the fusing member 11. A portion of the fusing nip N through which the print medium P passes is referred to as the paper passing area PA, and a portion of the fusing nip N through which the print medium P does not pass is referred to as the non-paper passing area NPA. Sizes of the paper passing area PA and the non-paper passing area NPA are not limited to examples illustrated in the drawing, and may be defined according to a size of the print medium P. When the print medium P having a small size passes, a width of the non-paper passing area NPA increases. Because direct heat transfer from the fusing member 11 to the print medium P does not occur in the non-paper passing area NPA, a temperature of the non-paper passing area NPA of the fusing member 11 may be higher than a temperature of the paper passing area PA of the fusing member 11 and the non-paper passing area NPA of the fusing member 11 is likely to be overheated.

Overheating of the non-paper passing area NPA of the fusing member 11 may cause thermal damage to members constituting the fuser 1 such as the fusing member 11 and the pressure member 12, and may be a factor that lowers the lifetime of the fuser 1. For example, internal members of the printing apparatus may be deformed or damaged by heat generated by the fuser 1. For example, a photosensitive layer of a photosensitive drum 212 described below may be damaged by heat. For example, the physical property of toner contained in a toner cartridge 91 described below may be degraded by heat. For example, overheating of the non-paper passing area NPA of the fusing member 11 may become more severe when the print medium P with a small width is printed. In order to prevent overheating, a printing speed may be lowered or an idle process in which the heater 13 does not operate during printing may be performed, which results in degradation of the printing performance of the printing apparatus.

In order to prevent overheating of the non-paper passing area NPA of the fusing member 11, the printing apparatus can include the ventilation device 100 for supplying cooling air to the non-paper passing area NPA of the fusing member 11. Referring to FIGS. 1 to 3, the ventilation device 100 may include a ventilation hole 101 facing the fusing member 11, and a ventilator 102 for supplying cooling air to the ventilation hole 101. The ventilation hole 101 faces the non-notification rea NPA of the fusing member 11. The ventilation device 100 has a structure capable of supplying cooling air to both ends of the fusing member 11 in the width direction Y. For example, the ventilation device 100 may include the first ventilation device 100-1 and the second ventilation device 100-2 symmetrically located on both sides with respect to the center line CL of the width direction Y. The first ventilation device 100-1 can face the non-paper passing area NPA on one side of the fusing member 11 in the width direction Y with respect to the center line CL, and the second ventilation device 100-2 can face the non-paper passing area NPA on the other side of the fusing member 11 in the width direction Y with respect to the center line CL. Each of the first and second ventilation devices 100-1 and 100-2 may include the ventilation hole 101 and the ventilator 102.

In order to determine whether the non-paper passing area NPA of the fusing member 11 is overheated, a method of detecting a temperature of the non-paper passing area NPA of the fusing member 11 by using a temperature sensor may be considered. The temperature sensor may be located outside the fusing member 11. In this case, the temperature sensor may be affected by cooling air supplied from the ventilation device 100, and it is difficult to accurately detect a temperature of the non-paper passing area NPA of the fusing member 11. For example, because the temperature sensor is located in a supply path of cooling air supplied to the non-paper passing area NPA of the fusing member 11, the cooling air may be prevented from contacting the fusing member 11, thereby reducing cooling efficiency.

A method of locating the temperature sensor inside the fusing member 11, for example, inside the fusing belt 11b, may be considered. To facilitate a rotational motion of the fusing belt 11b, a heat-resistant lubricant (e.g., fluorinated grease or silicone grease) can be applied to the inside of the fusing belt 11b. Because the lubricant has a very low thermal conductivity of 0.3 W/mk or less, when the lubricant gets on the temperature sensor, the performance of the sensor may be degraded. Because the temperature sensor contacts the inside of the fusing belt 11b, local abrasion of an inner circumferential surface of the fusing belt 11b may be caused, thereby causing image defects and reducing the lifetime of the fusing belt 11b. Because a temperature of a portion of the fusing belt 11b contacting the temperature sensor is lowered, printing defects may occur due to partial fusing defects.

According to the printing apparatus of the disclosure, the first temperature sensor 400 detects a temperature of the non-paper passing area NPA of the pressure member 12. The first temperature sensor 400 may be, for example, a thermistor. The first temperature sensor 400 may be a contact temperature sensor contacting the pressure member 12, or may be a non-contact temperature sensor spaced apart from the pressure member 12 by a certain distance. When the first temperature sensor 400 is a non-contact temperature sensor, the risk of damage to a surface of the pressure member 12 due to the sensor may be reduced. The pressure member 12 is located opposite to the fusing member 11 with respect to the fusing nip N. For example, the pressure member 12 is located opposite to the ventilation device 100 with respect to the fusing nip N. Accordingly, the first temperature sensor 400 can be located opposite to the ventilation device 100 with respect to the fusing nip N. According to this configuration, the first temperature sensor 400 may be less affected by cooling air supplied to the non-paper passing area NPA of the fusing member 11 by the ventilation device 100. Because the first temperature sensor 400 is not located in a supply path of cooling air supplied to the non-paper passing area NPA of the fusing member 11 by the ventilation device 100, the first temperature sensor 400 does not interfere with supply of cooling air to the non-paper passing area NPA of the fusing member 11.

A temperature of the pressure member 12 is affected by a temperature of the fusing member 11. Accordingly, it may be determined whether the non-paper passing area NPA of the fusing member 11 is overheated, by detecting a temperature of the non-paper passing area NPA of the pressure member 12. When a temperature detected by the first temperature sensor 400 is equal to or higher than a certain reference temperature, the controller 300 may determine that the non-paper passing area NPA of the fusing member 11 is overheated and may operate the ventilation device 100. For example, the controller 300 may drive the ventilator 102 to supply air to the non-paper passing area NPA of the fusing member 11 through the ventilation hole 101. When a temperature detected by the first temperature sensor 400 is lower than the certain reference temperature, the controller 300 may stop the ventilation device 100. The reference temperature may be a fusing temperature based on which the heater 13 is controlled. As the non-paper passing area NPA of the fusing member 11 is cooled, a temperature of the paper passing area PA of the fusing member 11 may be affected. Considering this point, the reference temperature may be a temperature slightly higher than the fusing temperature. A difference between the reference temperature and the fusing temperature may be appropriately determined in consideration of the ventilation capacity of the ventilation device 100 and the thermal conductivity of the fusing member 11.

In this configuration, overheating of the non-paper passing area NPA of the fusing member 11 may be prevented, and degradation of printing performance due to overheating of the non-paper passing area NPA may be prevented. Because overheating is prevented, the lifetime of the fuser 1 may be increased. For example, because thermal effect of the fuser 1 on other elements of the printing apparatus is reduced, the speed and the lifetime of the printing apparatus are increased. Because the first temperature sensor 400 is located to detect a temperature of the non-paper passing area NPA of the pressure member 12, the first temperature sensor 400 may be less affected by cooling air and a temperature of the non-paper passing area NPA of the pressure member 12 may be reliability detected. Because the first temperature sensor 400 does not interfere with supply of cooling air to the non-paper passing area NPA of the fusing member 11, the non-paper passing area NPA of the fusing member 11 may be effectively cooled.

The first temperature sensor 400 may be located at any of various positions to detect a temperature of the non-paper passing area NPA of the pressure member 12. An area outside the print medium P with a maximum width usable in the printing apparatus in the width direction Y in an entire length of the pressure member 12 in the width direction Y is always the non-paper passing area NPA through which the print medium P does not pass. Considering this point, as shown in FIGS. 2 and 3, the first temperature sensor 400 may include a first temperature sensor 401 located at a position outside the print medium P with the maximum width in the width direction Y to detect a temperature of the non-paper passing area NPA of the pressure member 12. The first temperature sensor 401 may be located on a side of the print medium P in the width direction Y, for example, on a side with respect to the center line CL. In the present example, the first temperature sensor 401 can be located at a position corresponding to the first ventilation device 101-1. The controller 300 may control the ventilation device 100 based on a temperature of the non-paper passing area NPA of the pressure member 12 detected by the first temperature sensor 401. The controller 300 may control the first and second ventilation devices 100-1 and 100-2 based on a temperature detected by the first temperature sensor 401, to supply air to two non-paper passing areas NPA on both sides of the fusing member 11 in the width direction Y.

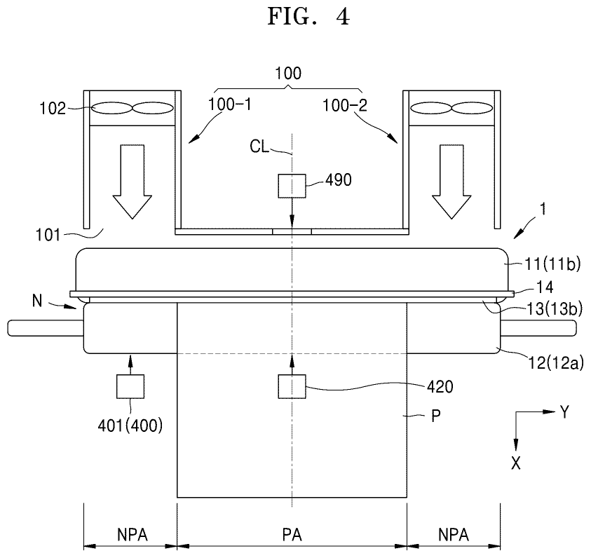

Hereinafter, a cooling structure of the fuser 1 using the fusing belt 11b and the planar heater 13b will be described. FIG. 4 is a schematic plan view illustrating a cooling structure of the fuser 1, according to an example. The cooling structure of the present example can be different from the cooling structure of FIGS. 2 and 3 in that a second temperature sensor 420 is used.

The controller 300 controls the ventilation device 100 to prevent overheating of the non-paper passing area NPA of the fusing member 11. In this case, a reference temperature based on which control is made may be a temperature of the paper passing area PA of the pressure member 12. To this end, the second temperature sensor 420 for detecting a temperature of the paper passing area PA of the pressure member 12 may be used. A central portion of the pressure member 12 can correspond to the paper passing area PA through which the print medium P passes even when the print medium P with a minimum width for printing. Accordingly, as shown in FIG. 4, the second temperature sensor 420 may detect a temperature around a central portion of the pressure member 12 in the width direction Y. The second temperature sensor 420 may be, for example, a thermistor. The second temperature sensor 420 may be a contact or non-contact temperature sensor. When the second temperature sensor 420 is a non-contact temperature sensor, the risk of surface damage to the paper passing area PA of the pressure member 12, a partial temperature drop of the paper passing area PA of the pressure member 12 due to the temperature sensor, and fusing defects may be prevented.

The controller 300 may detect a temperature around the central portion of the pressure member 12 by using the second temperature sensor 420, and may use the temperature as a reference temperature for starting and stopping an operation of the ventilation device 100 when the non-paper passing area NPA of the fusing member 11 is cooled. The controller 300 may control the ventilation device 100 based on a difference between a temperature (e.g., a detection temperature) of the non-paper passing area NPA of the pressure member 12 detected by the first temperature sensor 401 and a temperature (e.g., a reference temperature) of the paper passing area PA, for example, around the central portion, of the pressure member 12 detected by the second temperature sensor 420. For example, when printing is performed in a state where the ventilation device 100 is stopped, a temperature of the non-paper passing area NPA of the fusing member 11 can increase, and a temperature of the non-paper passing area NPA of the pressure member 12 can also increase. When a detection temperature detected by the first temperature sensor 401 is higher than a reference temperature detected by the second temperature sensor 420 by a reference difference or more, the controller 300 may operate the ventilation device 100. When the overheated non-paper passing area NPA of the fusing member 11 is cooled by cooling air supplied from the ventilation device 100, a temperature of the non-paper passing area NPA of the pressure member 12 can also be lowered. When a detection temperature detected by the first temperature sensor 401 is higher than a reference temperature by less than a reference difference, the controller 300 may stop the ventilation device 100. The reference difference may be appropriately determined in consideration of the ventilation capacity of the ventilation device 100 and the thermal conductivity of the fusing member 11.

When the non-paper passing area NPA of the fusing member 11 is cooled as described above, the paper passing area PA of the fusing member 11 may also be cooled due to heat conduction. Considering this point, by setting an operation condition of the ventilation device 100 based on a time when a detection temperature is higher than a reference temperature by a reference difference or more, a temperature of the paper passing area PA of the fusing member 11 may be maintained at a level suitable for fusing. Further, overheating of the non-paper passing area NPA of the fusing member 11 may be prevented. The controller 300 may operate the ventilation device 100 when a detection temperature detected by the first temperature sensor 401 is higher than a reference temperature detected by the second temperature sensor 420, and may stop the ventilation device 100 when a detection temperature detected by the first temperature sensor 401 is equal to a reference temperature detected by the second temperature sensor 420.

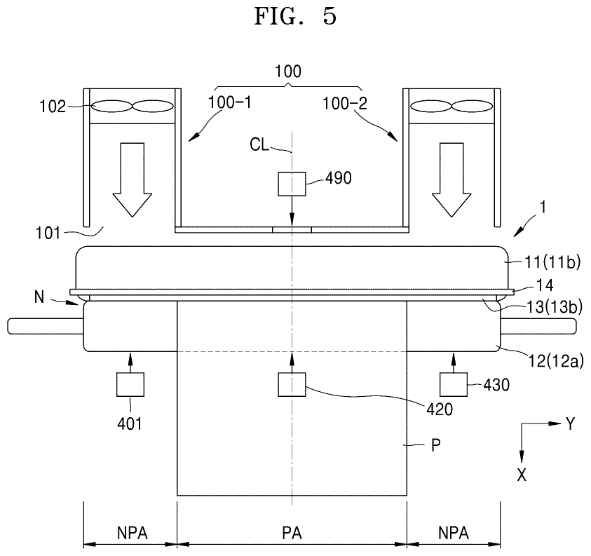

FIG. 5 is a schematic plan view illustrating a cooling structure of the fuser 1, according to an example. The cooling structure of the present example is different from the cooling structure of FIG. 4 in that that a third temperature sensor 430 is used. The difference will be mainly described.

When the print medium P is transported, both sides in the width direction Y can correspond to the non-paper passing areas NPA. In order to supply air to the two non-paper passing areas NPA, the ventilation device 100 can include the first and second ventilation devices 100-1 and 100-2. When any one of the first and second ventilation devices 100-1 and 100-2 malfunctions, cooling air may not be supplied to one of the two non-paper passing areas NPA, which may cause overheating. Considering this point, the printing apparatus according to an example of the disclosure can include a means for detecting whether the ventilation device 100 malfunctions. For example, the printing apparatus may include the third temperature sensor 430. The third temperature sensor 430 can be located opposite to the first temperature sensor 401 with respect to the width direction Y to detect a temperature of the non-paper passing area NPA of the pressure member 12. The third temperature sensor 430 may be located at a position of the pressure member 12 outside the print medium P with a maximum width in the width direction Y.

The controller 300 may determine whether the ventilation device 100 malfunctions according to a temperature detection result of the non-paper passing area NPA of the pressure member 12 by the first temperature sensor 401 and a temperature detection result of the non-paper passing area NPA of the pressure member 12 by the third temperature sensor 430 located outside the print medium P. For example, when at least one of temperatures detected by the first temperature sensor 401 and the third temperature sensor 430 indicates an overheated state when a certain time elapses since a start of an operation of the ventilation device 100, the controller 300 may determine that the ventilation device 100 malfunctions. The controller 300 may determine that the first ventilation device 100-1 malfunctions when only a temperature detected by the first temperature sensor 401 indicates an overheated state, may determine that the second ventilation device 100-2 malfunctions when only a temperature detected by the third temperature sensor 430 indicates an overheated state, and may determine that the first and second ventilation devices 100-1 and 100-2 malfunction when both temperatures detected by the first temperature sensor 401 and the third temperature sensor 430 indicate overheated states. When it is determined that the ventilation device 100 malfunctions, the controller 300 may control the printing apparatus to stop a printing operation. The controller 300 may generate a visual or audible error signal through a user interface 500. The user interface 500 can include, for example, a display device, a flashing device, or a buzzer.

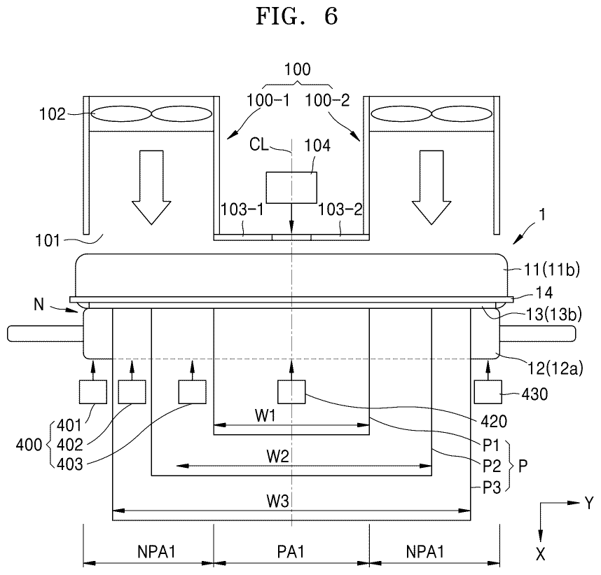

A plurality of print media P with different widths may be used in the printing apparatus. A range of the non-paper passing area NPA may vary according to a width of the print medium P for printing. The cooling structure of the fuser 1 may be a structure that may correspond to the range of the non-paper passing area NPA that varies according to the width of the print medium P for printing. FIG. 6 is a schematic plan view illustrating a cooling structure of the fuser 1, according to an example.

Referring to FIG. 6, a plurality of print media with different widths, for example, P1, P2, and P3, may be selectively used in a printing apparatus. The print medium P1 can include a print medium with a minimum width. The print medium P2 can include a medium with an intermediate width. The print medium P3 is a print medium with a maximum width. The first temperature sensor 400 may include a plurality of first temperature sensors (e.g., 401, 402, and 403). The plurality of first temperature sensors (e.g., 401, 402, and 403) are respectively located outside the plurality of print media P3, P2, and P1 in the width direction Y. For example, the first temperature sensor 401 is located outside the print medium P3 with the maximum width in the width direction Y, the first temperature sensor 402 is located outside the print medium P2 in the width direction Y, and the first temperature sensor 403 is located outside the print medium P3 with the minimum width in the width direction Y. A portion corresponding to the inside of the print medium P1 with the minimum width is always the paper passing area PA. Accordingly, the second temperature sensor 420 may be located inside the print medium P1 with the minimum width. The third temperature sensor 430 is located outside the print medium P3 with the maximum width in the width direction Y, and is located opposite to the first temperature sensor 401 with respect to the width direction Y.

The ventilation device 100 can include the first and second ventilation devices 100-1 and 100-2 as described above. In order to correspond to a range of the non-paper passing area NPA that varies according to a width of a print medium, the ventilation device 100 may include shutters 103-1 and 103-2 for adjusting an opening amount of the ventilation hole 101 and an actuator 104 for driving the shutters 103-1 and 103-2. The shutters 103-1 and 103-2 may slide, for example, in the width direction Y of the print medium P. The actuator 104 may cause the shutters 103-1 and 103-2 to slide in the width direction Y of the print medium P in order to adjust an opening amount of the ventilation hole 101. The actuator 104 may be implemented by any of various motors such as a rotary motor or a linear motor. The shutters 103-1 and 103-2 may slide in the width direction Y of the print medium P due to, for example, a rack-pinion driving structure. Although not shown in FIG. 6, first and second rack gears may be provided on the shutters 103-1 and 103-2. A pinion is engaged with the first and second rack gears. For example, the first and second rack gears are symmetrically located about the pinion. The actuator 104 may be, for example, a rotary motor. The pinion may be rotated by the rotary motor. In this configuration, the shutters 103-1 and 103-2 may slide symmetrically in the width direction Y, by rotating the rotary motor.

The controller 300 may control the ventilation device 100 based on a detection result of the first temperature sensor located outside the print medium P used for printing in the width direction Y from among the plurality of first temperature sensors 401, 402, and 403. For example, as described with reference to FIGS. 2 and 3, the controller 300 may operate or stop the ventilation device 100 according to whether a detection temperature of the non-paper passing area NPA of the pressure member 12 is equal to or higher than a certain reference temperature. As described with reference to FIG. 4, the controller 300 may control the ventilation device 100 based on a difference between a detection temperature of the non-paper passing area NPA of the pressure member 12 and a temperature (reference temperature) of the paper passing area PA, for example, around a central portion, of the pressure member 12 detected by the second temperature sensor 420. The third temperature sensor 430 is located opposite to the plurality of first temperature sensors 401, 402, and 403 and outside the print medium P3 with the maximum width to detect a temperature of the pressure member 12. As described with reference to FIG. 5, the controller 300 may determine whether the ventilation device 100 malfunctions based on temperatures detected by the third temperature sensor 430 and the first temperature sensor 401. For example, the controller 300 may determine whether the ventilation device 100 malfunctions according to temperature detection results of the first temperature sensor located outside the print medium P for printing in the width direction Y from among the plurality of first temperature sensors 401, 402, and 403 and the third temperature sensor 430.

When cooling air supplied by the ventilation device 100 is supplied to the paper passing area PA of the fusing member 11, the paper passing area PA of the fusing member 11 may be cooled and fusing defects may occur. Considering this point, the controller 300 may control the actuator 104 to adjust an opening amount of the ventilation hole 101 based on information about a width of the print medium P for printing. The controller 300 may slide the shutters 103-1 and 103-2 by controlling the actuator 104 not to supply air to the paper passing area PA based on the information about the width of the print medium P for printing.

Referring to FIG. 6, for example, the print medium P1 with the minimum width for printing. The print medium P1 passes through the fuser 1 by using a center feeding method. A portion of the fusing nip N through which the print medium P1 passes, that is, a portion corresponding to a width W1 of the print medium P1, is a paper passing area PA1, and widths of two non-paper passing areas NPA1 on both sides of the paper passing area PA1 are maximized. The controller 300 obtains width information of the print medium P1 from user setting information or detection information of a sensor, and controls the actuator 104 based on the width information to adjust an opening amount of the ventilation hole 101 to supply air to the non-paper passing area NPA1 of the fusing member 11 by moving the shutters 103-1 and 103-2. In the present example, an opening amount of the ventilation hole 101 is maximized. The controller 300 may selectively supply air to the non-paper passing area NPA1 of the fusing member 11 by controlling the ventilation device 100 based on a temperature detection result by at least one of the first temperature sensors 401, 402, and 402, or a temperature detection result by at least one of the first temperature sensors 401, 402, and 403 and the second temperature sensor 420. Accordingly, overheating of the two non-paper passing areas NPA1 of the fusing member 11 may be prevented when the print medium P1 with the minimum width passes through the fuser 1.

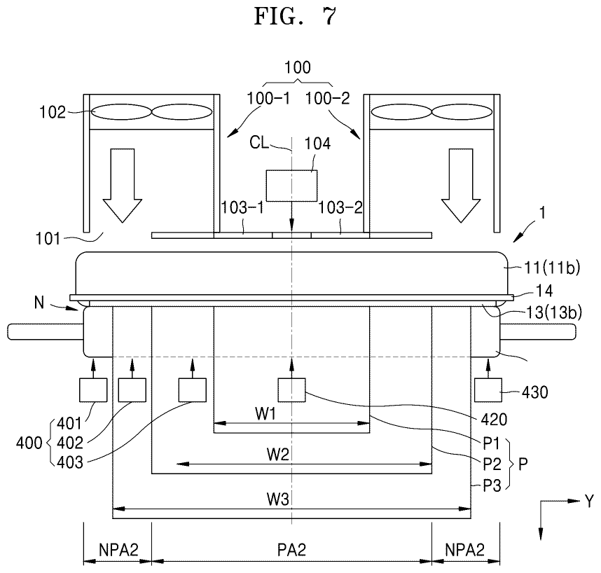

FIG. 7 is a schematic plan view illustrating a case where the print medium P2 with the intermediate width for printing in the cooling structure of the fuser 1 of FIG. 6, according to an example. Referring to FIG. 7, the print medium P2 with the intermediate width for printing. The print medium P2 passes through the fuser 1 by using a center feeding method. A portion of the fusing nip N through which the print medium P2 passes is a paper passing area PA2. For example, a width of the paper passing area PA2 is equal to a width W2 of the print medium P2. Two non-paper passing areas NPA2 on both sides of the paper passing area PA2 are areas through which the print medium P2 does not pass. The controller 300 obtains width information of the print medium P2 from user setting information or detection information of a sensor, and controls the actuator 104 based on the width information to adjust an opening amount of the ventilation hole 101 to supply air to the non-paper passing area NPA2 of the fusing member 11 by moving the shutters 103-1 and 103-2. The controller 300 may selectively supply air to the non-paper passing area NPA2 of the fusing member 11 by controlling the ventilation device 100 based on a temperature detection result by at least one of the first temperature sensors 401 and 402 or a temperature detection result by at least one of the first temperature sensors 401 and 402 and the second temperature sensor 420. Accordingly, overheating of the two non-paper passing areas NPA2 of the fusing member 11 may be prevented when the print medium P2 with the intermediate width passes through the fuser 1.

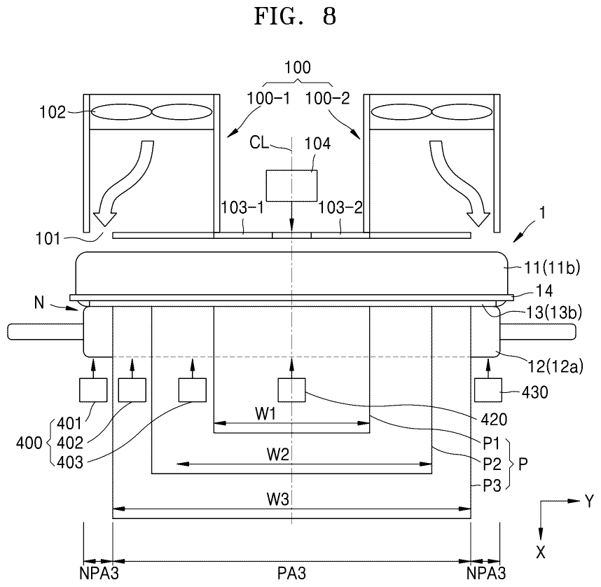

FIG. 8 is a schematic plan view illustrating a case where the print medium P3 with the maximum width for printing in the cooling structure of the fuser 1 of FIG. 6, according to an example. Referring to FIG. 8, the print medium P3 with the maximum width for printing. The print medium P3 passes through the fuser 1 by using a center feeding method. A portion of the fusing nip N through which the print medium P3 passes is a paper passing area PA3. For example, a width of the paper passing area PA3 is equal to a width W3 of the print medium P3. Two non-paper passing areas NPA3 on both sides of the paper passing area PA3 are areas through which the print medium P3 does not pass. The controller 300 obtains width information of the print medium P3 from user setting information or detection information of a sensor, and controls the actuator 104 based on the width information to adjust an opening amount of the ventilation hole 101 to supply air to the non-paper passing area NPA3 of the fusing member 11 by moving the shutters 103-1 and 103-2. In this case, an opening amount of the ventilation hole 101 is minimized. The controller 300 may selectively supply air to the non-paper passing area NPA3 of the fusing member 11 by controlling the ventilation device 100 based on a temperature detection result by the first temperature sensor 401 or a temperature detection result by the first temperature sensor 401 and the second temperature sensor 420. Accordingly, overheating of the two non-paper passing areas NPA3 of the fusing member 11 may be prevented when the print medium P3 with the maximum width passes through the fuser 1.

Information about a width of the print medium P may be obtained from any one of user setting information, detection information of a sensor for detecting a width of the print medium P, and detection temperature information of the plurality of first temperature sensors 401, 402, and 403. For example, as shown in FIG. 1, the printing apparatus may include the user interface 500. The user interface 500 may include, for example, an output device such as a display and an input device such as a button and a touchpad. A user may input information about a width of the print medium P loaded on a feeding cassette 201 user setting information through the input device.

For example, as shown in FIG. 1, the printing apparatus may include a width detection sensor 600 for detecting a width of the print medium P. The width detection sensor 600 may be located in, for example, the feeding cassette 201 to detect a width of the print medium P loaded on the feeding cassette 201. As marked by a dotted line in FIG. 1, the width detection sensor 600 may be located in a transport path 291 of the print medium P to detect a width of the transported print medium P. A plurality of width detection sensors 600 may be arranged in the width direction Y to detect the print media P with various widths.

The controller 300 may obtain information about a width of the print medium P based on temperatures detected by the plurality of first temperature sensors 401, 402, and 403 located outside the print medium P for printing in the width direction Y to adjust an opening amount of the ventilation hole 101 based on the information. For example, the controller 300 may obtain information about a width of the print medium P based on a position of a sensor indicating an overheated state of the non-paper passing area NPA of the fusing member 11 from among the plurality of first temperature sensors 401, 402, and 403, and may control the actuator 104 according to the obtained information about the width of the print medium P to adjust an opening amount of the ventilation hole 101 by moving the shutters 103-1 and 103-2.

For example, when the print medium P1 with the minimum width for printing and the non-paper passing area NPA1 of the fusing member 11 is overheated, sensing results of all of the first temperature sensors 401, 402, and 403 indicate an overheated state. In this case, the controller 300 may control the actuator 104 to adjust an opening amount of the ventilation hole 101 to supply air to the non-paper passing area NPA1 of the fusing member 11 by moving the shutters 103-1 and 103-2. Accordingly, overheating of the two non-paper passing areas NPA1 of the fusing member 11 may be prevented when the print medium P1 with the minimum width passes through the fuser 1.

For example, as shown in FIG. 7, when the print medium P2 with the intermediate width for printing, the first temperature sensor 403 is located in the paper passing area PA2, and thus, does not indicate an overheated state. That is, a portion of the pressure member 12 where the first temperature sensor 403 is installed is not overheated. Accordingly, the controller 300 may adjust an opening amount of the ventilation hole 101 based on detection temperatures of the first temperature sensors 401 and 402 located outside the print medium P2 in the width direction Y. When the non-paper passing area NPA2 of the fusing member 11 is overheated, sensing results of all of the first temperature sensors 401 and 402 indicate an overheated state. In this case, the controller 300 may control the actuator 104 to adjust an opening amount of the ventilation hole 101 to supply air to the non-paper passing area NPA2 of the fusing member 11 by moving the shutters 103-1 and 103-2. Accordingly, overheating of the two non-paper passing areas NPA2 of the fusing member 11 may be prevented when the print medium P2 with the intermediate width passes through the fuser 1.

For example, as shown in FIG. 8, when the print medium P3 with the maximum width for printing, the first temperature sensors 402 and 403 are located in the paper passing area PA3, and thus, do not indicate an overheated state. That is, portions of the pressure member 12 where the first temperature sensors 402 and 403 are installed are not overheated. Accordingly, the controller 300 may adjust an opening amount of the ventilation hole 101 based on a detection temperature of the first temperature sensor 401 located outside the print medium P3 in the width direction Y. When the non-paper passing area NPA3 of the fusing member 11 is overheated, a sensing result of the first temperature sensor 401 indicates an overheated state. In this case, the controller 300 may control the actuator 104 to adjust an opening amount of the ventilation hole 101 to supply air to the non-paper passing area NPA3 of the fusing member 11 by moving the shutters 103-1 and 103-2. Accordingly, overheating of the two non-paper passing areas NPA3 of the fusing member 11 may be prevented when the print medium P3 with the maximum width passes through the fuser 1.

Although the print medium P is transported by using a center feeding method in the above examples, the print medium P may be transported by using a side feeding method. The term “side feeding method” refers to a method by which the print media P with various widths are transported so that edges of the print media P in the width direction Y are matched. In this case, the first temperature sensor(s) (400 of FIGS. 2 to 5 or 401, 402, and 403 of FIGS. 6 to 8) may be located outside an edge opposite to an edge based on which side feeding of the print medium P is performed with respect to the width direction Y. The second temperature sensor 420 may be located inside the width of the print medium P with a minimum size, for example, the width W1 of the print medium P1, which is usable in the printing apparatus. The third temperature sensor 430 may be located outside the edge based on which side feeding of the print medium P is performed. The first ventilation device 100-1 may be located on the same side as the first temperature sensor(s) (400 of FIGS. 2 to 5 or 401, 402, and 403 of FIGS. 6 to 8), and the second ventilation device 100-2 may be located on the same side as the third temperature sensor 430. A structure of the toner image forming unit 2 according to an example will be described with reference to FIG. 1. Referring to FIG. 1, the toner image forming unit 2 forms a toner image on the print medium P by using an electrophotographic method. The toner image forming unit 2 of the present example forms a color toner image on the print medium P by using an electrophotographic method. The toner image forming unit 2 may include a plurality of developing devices 210, an exposure device 250, an intermediate transfer belt 260, a transfer roller 270, and a fuser 1.

The plurality of developing devices 210 may include four developing devices 210 for forming toner images of yellow (Y), magenta (M), cyan (C), and black (K) colors. Developers, for example, toner, of C, M, Y, and K colors may be respectively contained in the four developing devices 210. Toner of Y, M, C, and K colors is respectively contained in four toner cartridges 3. The toner of Y, M, C, and K colors may be respectively supplied from the four toner cartridges 91 to the four developing devices 210. The developing device 210 may include the photosensitive drum 212 on which an electrostatic latent image is formed and a developing roller 211. The developing device 210 develops the electrostatic latent image into a visible toner image by supplying toner to the electrostatic latent image.

A charging roller 215 charges the photosensitive drum 212 to have a uniform surface electric potential. The exposure device 250 forms an electrostatic latent image on the photosensitive drum 212 by emitting light modulated to correspond to image information to the photosensitive drum 212. The developing roller 211 can supply the toner contained in the developing device 210 to a developing region facing the photosensitive drum 212. The toner is supplied to the electrostatic latent image across the developing area by a developing bias voltage applied to the developing roller 211, and thus, the electrostatic latent image is developed into a visible toner image. The intermediate transfer belt 260 circulates by being supported by support rollers 262, 263, 264, and 265. Four intermediate transfer rollers 261 are located at positions facing the photosensitive drums 212 of the four developing devices 210 with the intermediate transfer belt 260 therebetween. The toner image developed on the photosensitive drum 212 is intermediately transferred to the intermediate transfer belt 260 by an intermediate transfer bias voltage applied to the intermediate transfer roller 261. A cleaning member 217 removes a developer remaining on a surface of the photosensitive drum 212 after the intermediate transferring process. The transfer roller 270 faces the intermediate transfer belt 260 to form a transfer nip. The print medium P is picked up from the feeding cassette 201 by a pickup roller 202 and is supplied to the transfer nip along the path 291. The toner image on the intermediate transfer belt 260 is transferred to the print medium P by a transfer bias voltage applied to the transfer roller 270. The fuser 1 fixes the toner image transferred to the print medium P by applying heat and pressure to the toner image. The print medium P that is been completely printed is discharged by a discharge roller 292.

It should be understood that examples described herein should be considered in a descriptive sense only and not for purposes of limitation. Descriptions of features or aspects within each example should typically be considered as usable for other similar features or aspects in other examples. While one or more examples have been described with reference to the figures, it will be understood by those of ordinary skill in the art that various changes in form and details may be made therein without departing from the spirit and scope as defined by the following claims.

1. A printing apparatus comprising:
a toner image forming unit configured to form a toner image on a print medium;
a fuser configured to fix the toner image to the print medium, the fuser comprising a fusing member, a heater configured to heat the fusing member, and a pressure member configured to form, together with the fusing member, a fusing nip through which the print medium passes;
a ventilation device to supply air to the fusing member in a width direction;
a first temperature sensor to detect a temperature of a non-paper passing area of the pressure member; and
a controller to control the ventilation device based on the temperature detected by the first temperature sensor.

2. The printing apparatus of claim 1, wherein the controller is to operate the ventilation device when the detected temperature is equal to or higher than a reference temperature, and stop the ventilation device when the detected temperature is lower than the reference temperature.

3. The printing apparatus of claim 1, comprising:
a second temperature sensor to detect a temperature around a central portion of the pressure member,
wherein the controller is to operate the ventilation device when the temperature detected by the first temperature sensor is higher than the temperature detected by the second temperature sensor by a certain reference difference or more.

4. The printing apparatus of claim 1, wherein the first temperature sensor is located outside a print medium with a maximum width in a width direction from among print media usable in the printing apparatus with respect to the pressure member.

5. The printing apparatus of claim 1, wherein the print medium comprises a plurality of print media with different widths,
wherein the first temperature sensor comprises a plurality of first temperature sensors respectively located outside the plurality of print media in the width direction, and
wherein the controller is to control the ventilation device based on a detection result of the first temperature sensor located outside a print medium used for printing in the width direction from among the plurality of first temperature sensors.

6. The printing apparatus of claim 1, wherein
the first temperature sensor is located on a side of the print medium in the width direction,
the ventilation device comprises first and second ventilation devices located around both ends of the fusing member, and
the ventilation device is to supply air to both ends of the fusing member in the width direction.

7. The printing apparatus of claim 6, comprising:
a third temperature sensor located opposite to the first temperature sensor and outside a print medium with a maximum width, the third temperature sensor being to detect a temperature of the pressure member,
wherein the controller is to determine whether the ventilation device malfunctions based on temperature detection results of the third temperature sensor and the first temperature sensor located outside the print medium.

8. The printing apparatus of claim 1, wherein the ventilation device comprises:
a ventilation hole facing the fusing member;
a ventilator to supply air to the ventilation hole;
a shutter to adjust an opening amount of the ventilation hole; and
an actuator to drive the shutter,
wherein the controller is further to control the actuator to adjust an opening amount of the ventilation hole based on information about a width of the print medium.

9. The printing apparatus of claim 8, wherein the information about the width of the print medium is obtained from any one of user setting information, detection information of a width detection sensor to detect a width of the print medium, and detection temperature information of the plurality of first temperature sensors.

10. The printing apparatus of claim 1, wherein the first temperature sensor is located opposite to the ventilation device with respect to the fusing nip.

11. A printing apparatus comprising:
a toner image forming unit to form a toner image on a print medium;
a fuser to fix the toner image to the print medium, the fuser comprising a fusing belt, a heater to heat the fusing belt, and a pressure roller to form, together with the fusing belt, a fusing nip through which the print medium passes;
first and second ventilation devices to supply air to the fusing belt in a width direction;
a plurality of first temperature sensors arranged in the width direction and to detect a temperature of a non-paper passing area on a side of the pressure roller; and
a controller to control the first and second ventilation devices based on the temperature of the non-paper passing area of the pressure roller detected by the first temperature sensor located outside a width of the print medium from among the plurality of first temperature sensors.

12. The printing apparatus of claim 11, comprising a second temperature sensor to detect a temperature around a central portion of the pressure roller,
wherein the controller is to control the first and second ventilation devices based on a difference between a temperature detected by the first temperature sensor located outside the width of the print medium from among the plurality of first temperature sensors and a temperature detected by the second temperature sensor.

13. The printing apparatus of claim 11, comprising a third temperature sensor located opposite to the plurality of first temperature sensors and outside a print medium with a maximum width, the third temperature sensor being to detect a temperature of the pressure roller,
wherein the controller is to determine whether the first and second ventilation devices malfunction according to temperature detection results of the third temperature sensor and the first temperature sensor located outside the print medium used for printing from among the plurality of first temperature sensors.

14. The printing apparatus of claim 11, wherein the first temperature sensor is a non-contact temperature sensor.

15. A fuser comprising:
a fusing belt;
a heater to heat the fusing belt;
a pressure member to form, together with the fusing belt, a fusing nip through which the print medium passes; and
at least one first temperature sensor to detect a temperature of a non-paper passing area of the pressure member.
